(19) United States
(12) Patent Application Publication
(10) Pub. No.: US 2008/0301569 A1
(43) Pub. Date: Dec. 4, 2008

(54) Image-displaying device

(75) Inventor: Koji Akagi, Aichi-ken (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 12/153,843

(22) Filed: May 27, 2008

(30) Foreign Application Priority Data
May 31, 2007 (JP) P2007-145155

(51) Int. Cl. G06F 3/048

(52) U.S. Cl. 715/761

(57) ABSTRACT

An image-displaying device includes a storing unit, a displaying unit, a controller. The storing unit stores a first correlation data and a second correlation data. The first correlation data indicates a plurality of first thumbnails including a plurality of first display thumbnails and also indicates a sequence of the plurality of first thumbnails. The second correlation data indicates a plurality of second thumbnails including a plurality of second display thumbnails and also indicates a sequence of the plurality of second thumbnails. The displaying unit includes a first display configured to display a plurality of first display thumbnails as a first thumbnail row extending in a predetermined direction based on the first correlation data, and a second display configured to display a plurality of second display thumbnails as a second thumbnail row extending in the predetermined direction based on the second correlation data. The controller controls the first display to change a first display thumbnail in the first thumbnail row and to control the second display to maintain displaying the plurality of second display thumbnails in response to the first changing instruction, and the controller controls the second display to change a second display thumbnail in the second thumbnail row and to control the first display to maintain displaying the plurality of first display thumbnails in response to the second changing instruction.

### CROSS REFERENCE TO RELATED APPLICATION

This application claims priority from Japanese Patent Application No. 2007-145155 filed May 31, 2007. The entire content of each of these priority applications is incorporated herein by reference.

### TECHNICAL FIELD

The present invention relates to an image-displaying device for maintaining the display state of thumbnail images in either a first or a second thumbnail row, while allowing the user to shift the thumbnail images displayed in the other thumbnail row.

### BACKGROUND

An image-displaying device including displaying means for displaying thumbnail images created from data for a plurality of images is well known in the art. One such image-displaying device disclosed in Japanese unexamined patent application publication No. 2005-109907 displays a prescribed number of thumbnail images in an image selection menu (a window for selecting images to be printed) based on image data recorded on a storage medium 202 (for example, the menu may be sized to display twelve thumbnail images simultaneously). A Previous button BT5 and a Next button BT6 are displayed below the thumbnail images for shifting the display to the previous twelve thumbnail images or the next twelve thumbnail images. When the user selects the Previous button BT5, the image-displaying device replaces the currently displayed thumbnail images with the previous prescribed number of thumbnail images. When the user selects the Next button BT6, the image-displaying device replaces the currently displayed thumbnail images with the next prescribed number of thumbnail images.

### SUMMARY

However, when displaying both a first thumbnail row including a plurality of thumbnail images displayed in a row and a second thumbnail row including a plurality of images displayed in a row parallel to the first thumbnail row, the technology disclosed in Japanese unexamined patent application publication No. 2005-109907 described above cannot meet the needs of a user wishing to maintain the display of either the first thumbnail row or the second thumbnail row while maintaining the display state of the other thumbnail row unchanged.

In view of the above-described drawbacks, it is an objective of the present invention to provide an image-displaying device capable of maintaining the display state of one thumbnail row among first and second thumbnail rows, while allowing the user to shift thumbnail images displayed in the other thumbnail row.

In order to attain the above and other objects, the present invention provides an image-displaying device including a storing unit, a displaying unit, a receiving unit, a detecting unit, and a controller. The storing unit stores a first correlation data and a second correlation data. The first correlation data indicates a plurality of first thumbnails including a plurality of first display thumbnails and also indicates a sequence of the plurality of first thumbnails. The second correlation data indicates a plurality of second thumbnails including a plurality of second display thumbnails and also indicates a sequence of the plurality of second thumbnails. The displaying unit includes a first display configured to display a plurality of first display thumbnails as a first thumbnail row extending in a predetermined direction based on the first correlation data, and a second display configured to display a plurality of second display thumbnails as a second thumbnail row extending in the predetermined direction-based on the second correlation data. The receiving unit includes a first receiving unit configured to receive a first changing instruction, and a second receiving unit configured to receive a second changing instruction. The detecting unit detects that the first receiving unit has received the first changing instruction and the second receiving unit has received the second changing instruction. The controller controls the first display to change a first display thumbnail in the first thumbnail row and to control the second display to maintain displaying the plurality of second display thumbnails if the detecting unit detects that the first receiving unit has received the first changing instruction, and the controller controls the second display to change a second display thumbnail in the second thumbnail row and to control the first display to maintain displaying the plurality of first display thumbnails if the detecting unit detects that the second receiving unit has received the second changing instruction.

### BRIEF DESCRIPTION OF THE DRAWINGS

The particular features and advantages of the invention as well as other objects will become apparent from the following description taken in connection with the accompanying drawings, in which:

FIG. 1 is a perspective view showing the outer structure of a multifunction device;

FIG. 2 is a block diagram showing the general structure of a controller in the multifunction device;

FIG. 3 is an explanatory diagram showing (a) a thumbnail image display according to a first embodiment, and (b) a coordinate table according to the first embodiment;

FIG. 4 is a flowchart illustrating steps in a thumbnail shifting process according to the first embodiment;

FIG. 5 is an explanatory diagram showing (a1-a3) the thumbnail image display according to the first embodiment, and (b1 and b2) a thumbnail list according to the first embodiment;

FIG. 6 is an explanatory diagram showing (a) a thumbnail image display according to a second embodiment, and (b) a coordinate table according to the second embodiment;

FIG. 7 is a flowchart illustrating steps in a thumbnail shifting process according to the second embodiment;

FIG. 8 is an explanatory diagram showing (a1-a3) the thumbnail image display according to the second embodiment, and (b1 and b2) a thumbnail list according to the second embodiment;

FIG. 9 is an explanatory diagram showing a thumbnail image display according to a variation of the second embodiment;

FIG. 10 is a flowchart illustrating steps in a thumbnail shifting process according to a third embodiment;

FIG. 11 is an explanatory diagram showing (a1-a3) the thumbnail image display according to the third embodiment, and (b1 and b2) a thumbnail list according to the third embodiment;

FIG. 12 is a flowchart illustrating steps in a thumbnail shifting process according to a fourth embodiment; and

FIG. 13 is an explanatory diagram showing (a1-a3) the thumbnail image display according to the fourth embodiment, and (b1 and b2) a thumbnail list according to the fourth embodiment.

### DETAILED DESCRIPTION

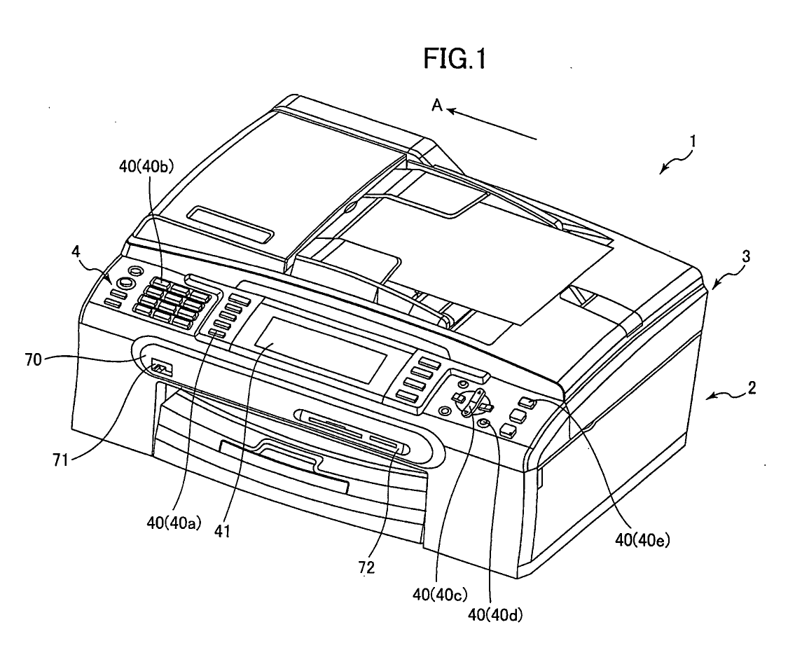

Next, preferred embodiments of the present invention will be described while referring to the accompanying drawings. FIG. 1 is a perspective view showing the outer structure of a multifunction device 1 according to the preferred embodiments. A feature of the present invention is that the multifunction device 1 can maintain the display state of one thumbnail row among a presorted thumbnail row and a sorted thumbnail row, while allowing the user to shift thumbnail images (hereinafter also referred to simply as “thumbnails”) displayed in the other thumbnail row.

As shown in FIG. 1, the multifunction device 1 is integrally configured of a printer 2 occupying the lower section, a scanner 3 occupying the upper section, and a control panel 4 provided on the front surface of the scanner 3. The multifunction device 1 has a scanner function, copier function, and facsimile function.

In addition to the above functions, the multifunction device 1 has a function for connecting to external devices, such as a USB memory device, a digital camera, and a personal computer and for recording data received from these external devices on a recording paper K; and a function for displaying data received from the external devices on a liquid crystal display (LCD) 41 provided on the control panel -4.

The control panel 4 is disposed on the front surface side of the multifunction device 1 and is used for operating the printer 2 and scanner 3. The control panel 4 includes various operating keys 40 (40a, 40b, 40c, 40d, and 40e), and the LCD 41.

The LCD 41 is rectangular in shape and elongated in the direction indicated by an arrow A in FIG. 1 (width direction of the multifunction device 1) and has a vertical-to-horizontal ratio of 3:8, where the width direction is the horizontal. More specifically, the LCD 41 is integrally configured of two independent rectangular LCDs having a vertical-to-horizontal ratio of 3:4 and juxtaposed in the direction A, although the LCD 41 is not shown to scale in FIG. 1.

The LCD 41 is also integrally configured of a direct touch panel well known in the art. By directly touching thumbnails, icons, and the like displayed on the LCD 41, the user can select such images and icons located at the touched coordinates of the LCD 41. In addition to directly touching a specific region of the display, the user can trace a desired path on the LCD 41, at which time the touch panel also recognizes the final coordinates in the path traced on the LCD 41.

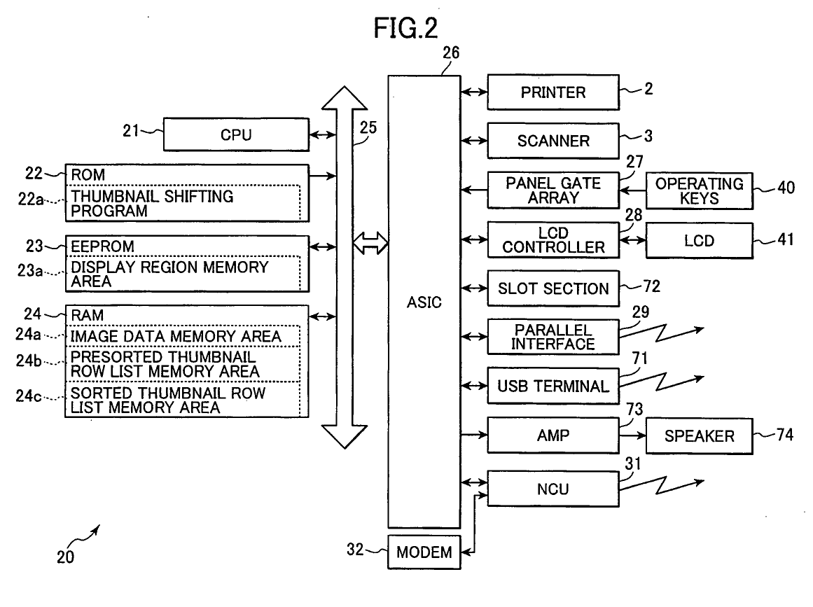

When the user inputs a desired command into the multifunction device 1, a controller 20 (see FIG. 2) controls operations of the multifunction device 1 based on the inputted data. In addition to commands inputted via the control panel 4, the multifunction device 1 can be operated based on commands transmitted from a computer via a printer driver, scanner driver, and the like.

A connection panel 70 is provided below the control panel 4. A USB terminal 71 is provided in the left side of the connection panel 70. The USB terminal 71 allows the multifunction device 1 to be connected with a USB cable to an external device so that the external device and the multifunction device 1 can communicate with each other.

A slot section 72 is disposed in the right side of the connection panel 70. The slot section 72 is provided with a plurality of card slots in which memory cards (card-like memory) may be inserted. When a memory card is inserted into a card slot, the controller 20 described later can read image data from the memory card.

Next, the overall structure of the controller 20 that controls operations of the multifunction device 1 will be described with reference to FIG. 2. FIG. 2 is a block diagram showing the overall structure of the controller 20. The controller 20 controls overall operations of the multifunction device 1, including the printer 2, scanner 3, and control panel 4.

The controller 20 is configured of a microcomputer primarily including a central processing unit (CPU) 21, a read-only memory (ROM) 22, an electrically erasable programmable ROM (EEPROM) 23, and a random access memory (RAM) 24, all of which are connected to an application specific integrated circuit (ASIC) 26 via a bus 25.

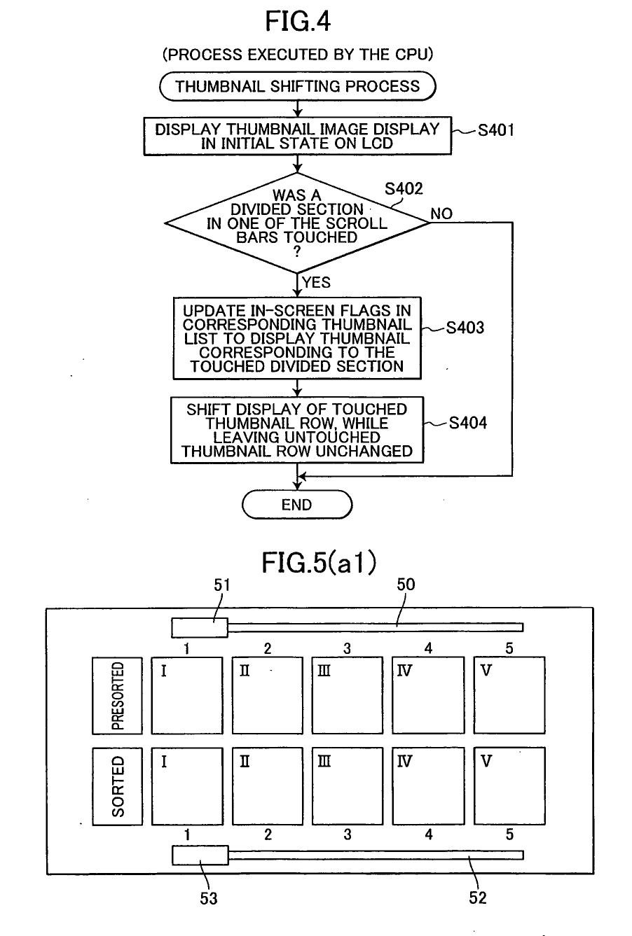

The CPU 21 performs overall control of the multifunction device 1 based on programs stored in the ROM 22. The ROM 22 stores programs for controlling various operations of the multifunction device 1, including a thumbnail shifting program 22a for implementing an thumbnail shifting program shown in the flowchart of FIGS. 4, 7, 10, and 12. The thumbnail shifting process functions to maintain the displays state of thumbnails in one of the presorted thumbnail row and the sorted thumbnail row, while allowing the user to shift thumbnails displayed in the other thumbnail row.

The EEPROM 23 is a rewritable nonvolatile memory and includes a display region memory area 23a. The display region memory area 23a stores display regions S1-S5 of thumbnails, display regions B1 and B2 of icons, and the like displayed on the LCD 41 in association with their coordinates relative to the LCD 41.

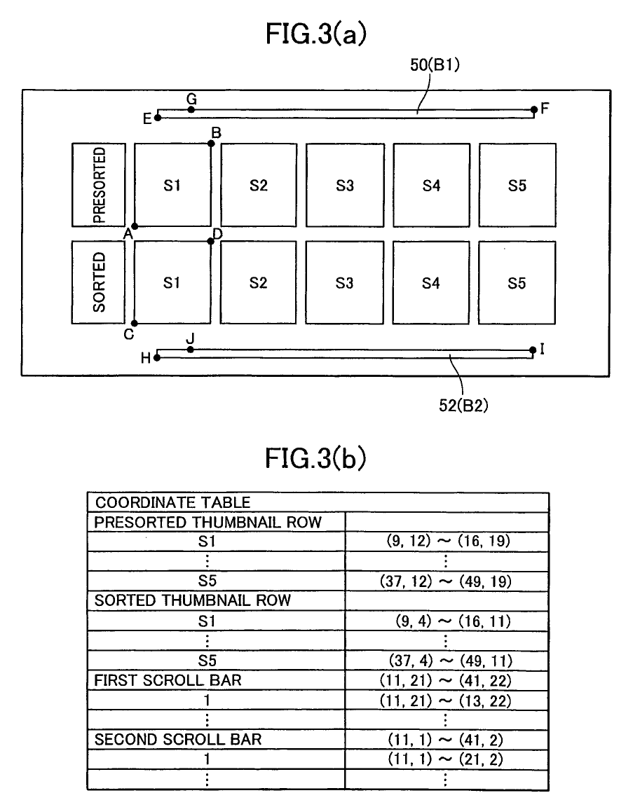

The display region memory area 23a will be described here in greater detail with reference to FIG. 3. FIG. 3(a) illustrates the display positions of thumbnails and icons on the LCD 41 when displaying the thumbnail image display according to the first embodiment on the LCD 41. FIG. 3(b) conceptually illustrates a coordinate table according to the first embodiment stored in the display region memory area 23a.

As shown in FIG. 3(a), the thumbnail image display according to the first embodiment includes two thumbnail rows displayed in parallel on the LCD 41. The thumbnail rows are a presorted thumbnail row having thumbnails corresponding to image data arranged in the original presorted order, and a sorted thumbnail row having thumbnails for image data arranged in a modified order.

The presorted thumbnail row includes thumbnails for image data stored in an image data memory area 24a described later displayed in a prescribed order (according to the modified date, size, or the like). The sorted thumbnail row includes the same thumbnails displayed in the presorted thumbnail row after the display order has been rearranged according to user instructions.

The presorted thumbnail row in the thumbnail image display includes a maximum of five pages worth of thumbnails in their original unmodified order juxtaposed horizontally beginning from the character string “Presorted.” Display regions S1-S5 for displaying the five pages worth of thumbnails are stored in the coordinate table in association with coordinates on the LCD 41.

For example, as indicated in FIG. 3, the leftmost display region S1 in the presorted thumbnail row is stored in association with two points A and B on the LCD 41 having coordinates (9, 12) and (16, 19), respectively. The coordinates for these two points define a rectangular region corresponding to the display region S1. Similarly, each of the display regions S2-S5 in the presorted thumbnail row is stored in association with coordinates for two points on the LCD 41, enabling a touch panel or the like configuring the LCD 41 to detect direct input for each of the display regions S1-S5.

The sorted thumbnail row is displayed below the presorted thumbnail row in the thumbnail image display and also includes a maximum of five pages worth of thumbnails juxtaposed horizontally in a modified order beginning from the character string “Sorted.” The display regions S1-S5 for displaying the five pages worth of thumbnails are stored in the coordinate table in association with coordinates on the LCD 41.

For example, as indicated in FIG. 3, the leftmost display region S1 in the sorted thumbnail row is stored in association with two points C and D on the LCD 41 having coordinates (9, 4) and (16, 11), respectively. The coordinates for these two points define a rectangular region corresponding to the display region S1. Similarly, each of the display regions S2-S5 in the sorted thumbnail row is stored in association with coordinates for two points on the LCD 41, enabling a touch panel or the like configuring the LCD 41 to detect direct input for each of the display regions S1-S5.

A first scroll bar 50 is displayed in a display region B1 above the presorted thumbnail row. The first scroll bar 50 is an icon that accepts instructions for scrolling the thumbnails displayed in the presorted thumbnail row left and right.

The display region B1 in which the first scroll bar 50 is displayed is divided uniformly in the longitudinal direction by the total number of the presorted image data to be displayed, and each divided section of the display region B1 is stored in the coordinate table in association with corresponding coordinates on the LCD 41. That is, the total length of the first scroll bar 50 in the longitudinal direction corresponds to the total number of presorted images and indicates each page worth of data in order from the left side. For example, if the total number of presorted images is 30, the left longitudinal edge of the first scroll bar 50 indicates the first page, the middle position indicates the fifteenth page, and the right edge indicates the thirtieth page.

More specifically, as shown in FIG. 3(b), the display region B1 of the first scroll bar 50 is stored in the coordinate table in association with two points E and F on the LCD 41 having coordinates (11, 21) and (41, 22), respectively. The display region B1 is also divided uniformly in the longitudinal direction by the total number of presorted images to be displayed, and each divided section of the display region B1 is stored in association with coordinates for two points on the LCD 41.

For example, a divided section for the first page is stored in association with the two coordinates E and G on the LCD 41 having coordinates (11, 21) and (13, 22), respectively, which coordinates define a rectangular region corresponding to the divided section for the first page. In this way, the touch panel configuring the LCD 41 can detect when direct input is received for one of the divided sections of the display region B1.

Further, a second scroll bar 52 is displayed in a display region B2 below the sorted thumbnail row. The second scroll bar 52 is an icon that accepts instructions for scrolling the thumbnails displayed in the sorted thumbnail row left and right.

The display region B2 in which the second scroll bar 52 is displayed is divided uniformly in the longitudinal direction by the total number of the sorted images to be displayed, and each divided section of the display region B2 is stored in the coordinate table in association with corresponding coordinates on the LCD 41. That is, the total length of the second scroll bar 52 in the longitudinal direction corresponds to the total number of sorted images and indicates each page worth of data in order from the left side. For example, if the total number of sorted images is 10, the left longitudinal edge of the second scroll bar 52 indicates the first page, the middle position indicates the fifth page, and the right edge indicates the tenth page.

More specifically, as shown in FIG. 3(b), the display region B2 of the second scroll bar 52 is stored in the coordinate table in association with two points H and I on the LCD 41 having coordinates (11, 1) and (41, 2), respectively. The display region B2 is also divided uniformly in the longitudinal direction by the total number of sorted images to be displayed, and each divided section of the display region B2 is stored in association with coordinates for two points on the LCD 41.

For example, a divided section for the first page is stored in association with the two coordinates H and J on the LCD 41 having coordinates (11, 1) and (21, 2), respectively, which coordinates define a rectangular region corresponding to the divided section for the first page. In this way, the touch panel configuring the LCD 41 can detect when direct input is received for one of the divided sections of the display region B2.

The RAM 24 of the controller 20 shown in FIG. 2 is used as a storage area for temporarily storing various data used when the CPU 21 executes the above programs and as a work area for the CPU 21. The RAM 24 includes an image data memory area 24a, a presorted thumbnail list memory area 24b, and a sorted thumbnail list memory area 24c.

The image data memory area 24a stores image data of thumbnail images displayed in the thumbnail image display. The image data stored in the image data memory area 24a is read from a memory card, internal memory such as the EEPROM 23, or the scanner 3.

The presorted thumbnail list memory area 24b stores a list of the presorted thumbnails. Thumbnails are displayed in the presorted thumbnail row according to this list of presorted thumbnails.

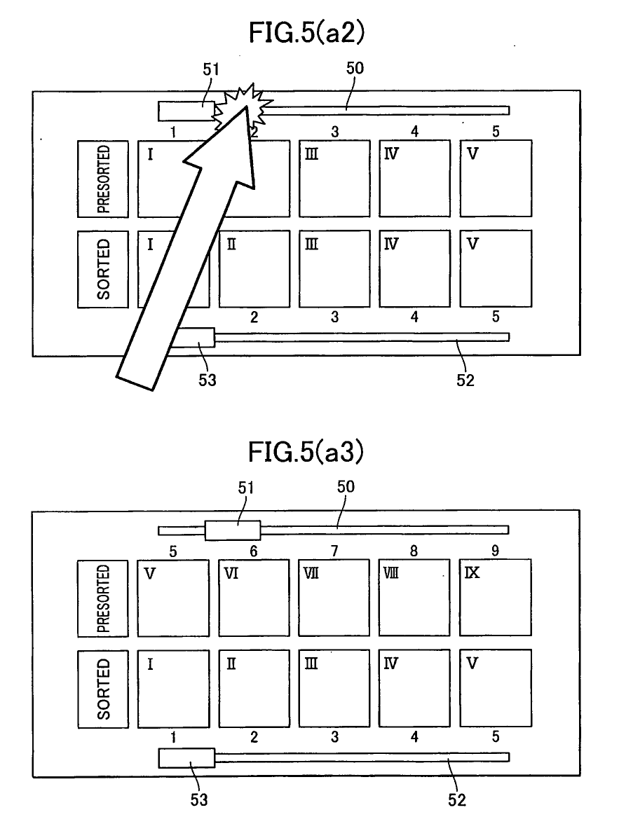

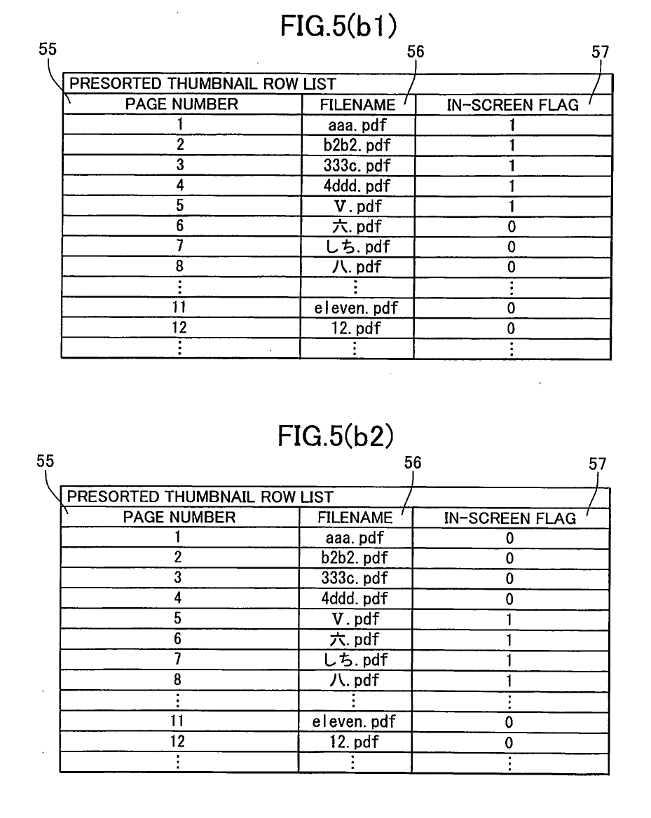

The list of presorted thumbnails will be described here with reference to FIG. 5(b1). FIG. 5(b1) conceptually illustrates the list of presorted thumbnails in an initial state according to the first embodiment.

The list of presorted thumbnails shown in FIG. 5(b1) associates a page number 55, an image filename 56, and an in-screen flag 57 with each thumbnail image (each image data).

The page number 55 indicates the order in which each thumbnail image is displayed in the presorted thumbnail row. The image filename 56 indicates the filename of the image data corresponding to each thumbnail image. The image filename 56 can be used to identify the image data corresponding to the thumbnail. The in-screen flag 57 indicates whether the thumbnail image is displayed on the LCD 41 and is set to “1” when displayed and “0” when not displayed.

In the preferred embodiment, the in-screen flag 57 is initially set to “1” for thumbnails having a page number 55 of “1-5”. The thumbnails having a in-screen flag 57 set to “1” are displayed from left to right in the presorted thumbnail row in increasing order of the page numbers 55.

Hence, if the list of presorted thumbnails is in the state shown in FIG. 5(b1), thumbnails corresponding to the image filenames “aaa.pdf,” “b2b2.pdf,” “333c.pdf,” “4ddd.pdf,” and “V.pdf” in order from left to right in display regions S1-S5 of the presorted thumbnail row shown in FIG. 3(a).

The sorted thumbnail list memory area 24c stores a list of sorted thumbnails. Thumbnails are displayed in the sorted thumbnail row according to this list of sorted thumbnails. Since the list of sorted thumbnails is identical to the list of presorted thumbnails described above, a detailed description of this list will not be repeated.

The ASIC 26 controls operations of the printer 2, scanner 3, control panel 4, slot section 72, and the like based on instructions from the CPU 21.

The ASIC 26 is connected to a panel gate array 27 for receiving commands inputted from the operating keys 40, an LCD controller 28 for controlling the display on the LCD 41, a parallel interface 29 for exchanging data with a computer via a parallel cable or a USB cable, the USB terminal 71, and a speaker 74 via a amp 73. The ASIC 26 is also connected to a network control unit (NCU) 31, and a modem 32 is connected to the NCU 31.

FIG. 4 is a flowchart illustrating steps in a thumbnail shifting process according to the first embodiment. This process serves to maintain the display state of either the presorted thumbnail row or the sorted thumbnail row and to rearrange and display thumbnails in the other thumbnail row based on user instructions. The process is executed when the user inputs an instruction.

In S401 of the thumbnail shifting process shown in FIG. 4, the CPU 21 displays the thumbnail image display in its initial state on the LCD 41. Specifically, when the user issues an instruction to display the thumbnail image display, the CPU 21 creates the list of presorted thumbnails based on image data stored in the image data memory area 24a and stores this list of presorted thumbnails in the presorted thumbnail list memory area 24b. The CPU 21 also stores a list of sorted thumbnails in the same state as the list of presorted thumbnails in the sorted thumbnail list memory area 24c.

At the same time, the CPU 21 divides the display region of the first scroll bar 50 based on the total number of image data included in the presorted thumbnail row, assigns coordinates on the LCD 41 to each divided section, and stores the divided sections and assigned coordinates in the coordinate table. Similarly, the CPU 21 divides the display region of the second scroll bar 52 based on the total number of image data included in the sorted thumbnail row, assigns coordinates on the LCD 41 to each divided section, and stores the divided sections and assigned coordinates in the coordinate table.

Next, the CPU 21 displays the presorted thumbnail row based on the list of presorted thumbnails and the sorted thumbnail row based on the list of sorted thumbnails together with the scroll bars 50 and 52 on the LCD 41.

The initial state of the thumbnail image display according to the first embodiment will be described here in detail with reference to FIGS. 5(a1) and 5(b1). FIG. 5(a1) shows the initial state of the thumbnail image display according to the first embodiment, and FIG. 5(b1) is a list of presorted thumbnails in the initial state according to the first embodiment.

The presorted thumbnail row shown in FIG. 5(a1) is displayed based on the list of presorted thumbnails shown in FIG. 5(b1). Specifically, thumbnails having an in-screen flag 57 set to “1” in the list of presorted thumbnails shown in FIG. 5(b1) are displayed in increasing order of the page numbers 55 from left to right in the presorted thumbnail row. Further, a roman numeral (I, II, III, etc.) corresponding to the page number 55 of each thumbnail is displayed in association with each thumbnail displayed in the presorted thumbnail row.

Further, the sorted thumbnail row is displayed based on the list of sorted thumbnails (not shown). Since the list of sorted thumbnails is set to the same state as the list of presorted thumbnails shown in FIG. 5(b1) initially, as described above, the same thumbnails as those in the presorted thumbnail row are initially displayed in the sorted thumbnail row in the same order.

Icons for each of the scroll bars 50 and 52 are also displayed in the thumbnail image display based on the coordinates for the LCD 41 stored in the coordinate table. Pointers 51 and 53 that move along the scroll bars 50 and 52 are displayed at the left end of the scroll bars 50 and 52, respectively. The order for displaying the presorted thumbnail row, sorted thumbnail row, scroll bars 50 and 52, and pointers 51 and 53 is not necessarily limited to the order given above.

Since the first scroll bar 50, presorted thumbnail row, sorted thumbnail row, and second scroll bar 52 are arranged in order from top to bottom in the thumbnail image display, the user can easily recognize that the first scroll bar 50 corresponds to the presorted thumbnail row and the second scroll bar 52 to the sorted thumbnail row, thereby reducing the chance of incorrect operations.

Returning to the flowchart in FIG. 4, after displaying the thumbnail image display in its initial state in S401, in S402 the CPU 21 determines whether a divided section in one of the scroll bars 50 and 52 has been touched. If a divided section has not been touched (S402: NO), the CPU 21 ends the thumbnail shifting process. However, if one of the divided sections was touched (S402: YES), in S403 the CPU 21 updates the in-screen flags 57 in the list of thumbnails corresponding to the touched divided section in order to display thumbnails corresponding to the touched divided section. Specifically, the CPU 21 sets in-screen flags 57 for five thumbnails, including the in-screen flag 57 of the thumbnail corresponding to the touched divided section to “1” and sets all other in-screen flags 57 to “0”.

In S404 the CPU 21 shifts the display of thumbnails in the thumbnail row corresponding to the touched scroll bar, while leaving the display of the other thumbnail row unchanged. Subsequently, the CPU 21 ends the thumbnail shifting process.

This process will be described in greater detail with reference to FIG. 5. FIG. 5(a2) shows the initial state of the thumbnail image display in FIG. 5(a1) when the user touches the first scroll bar 50. FIG. 5(a3) shows the thumbnail image display after the CPU 21 shifts the presorted thumbnail row. FIG. 5(b2) shows the list of presorted thumbnails after the in-screen flags 57 have been updated from the initial state shown in FIG. 5(b1).

Hence, while the thumbnail image display is in its initial state shown in FIG. 5(a1), the user touches the fifth divided section from the left in the first scroll bar 50 (indicated by the point of the arrow in the drawing), as shown in FIG. 5(a2).

At this time, the CPU 21 detects the coordinates of the LCD 41 touched by the user and determines which divided section of which scroll bar was touched by referencing the coordinate table with the detected coordinates. In this example, the CPU 21 detects that the fifth divided section from the left in the first scroll bar 50 was touched. Accordingly, the CPU 21 updates the in-screen flags 57 in the list of presorted thumbnails shown in FIG. 5(b1) to the state shown in FIG. 5(b2). Specifically, the CPU 21 sets the in-screen flags 57 corresponding to page numbers 55 “5-9” to “1” and sets all other in-screen flags 57 to “0”.

Next, the CPU 21 updates the thumbnail image display from the state shown in FIG. 5(a1) to the state shown in FIG. 5(a3) based on the updated list of presorted thumbnails. That is, the CPU 21 displays the five thumbnails corresponding to page numbers 55 of “5-9” (roman numerals V-IX) in order from left to right in the presorted thumbnail row, while leaving the sorted thumbnail row unchanged.

Further, when the CPU 21 detects the touched coordinates in the first scroll bar 50, the CPU 21 displays the pointer 51 at the detected coordinate position, as shown in FIG. 5(a3). In this way, the user can readily determine the general position in the overall thumbnail order to which the currently displayed thumbnails belong.

Through the thumbnail shifting process according to the first embodiment described above, the multifunction device 1 can maintain the display state of one of the presorted thumbnail row and sorted thumbnails row, while shifting the display of thumbnails in the other thumbnail row according to the user's instructions. Further, the user can predict which thumbnails will be displayed on the LCD 41 based on the first scroll bar 50 or second scroll bar 52 and can input instructions for displaying thumbnails through the simple operation of touching the corresponding part of the first scroll bar 50 or second scroll bar 52.

While the above embodiment describes the case of shifting the display in the presorted thumbnail row, the user may also touch a desired position on the second scroll bar 52 in the same way to shift the display in the sorted thumbnail row while leaving the presorted thumbnail row unchanged.

Further, while the thumbnail corresponding to the divided section touched by the user is displayed in the leftmost region of the thumbnail row, the thumbnail corresponding to the touched divided section may be displayed at any position in the thumbnail row and is not restricted to the leftmost position.

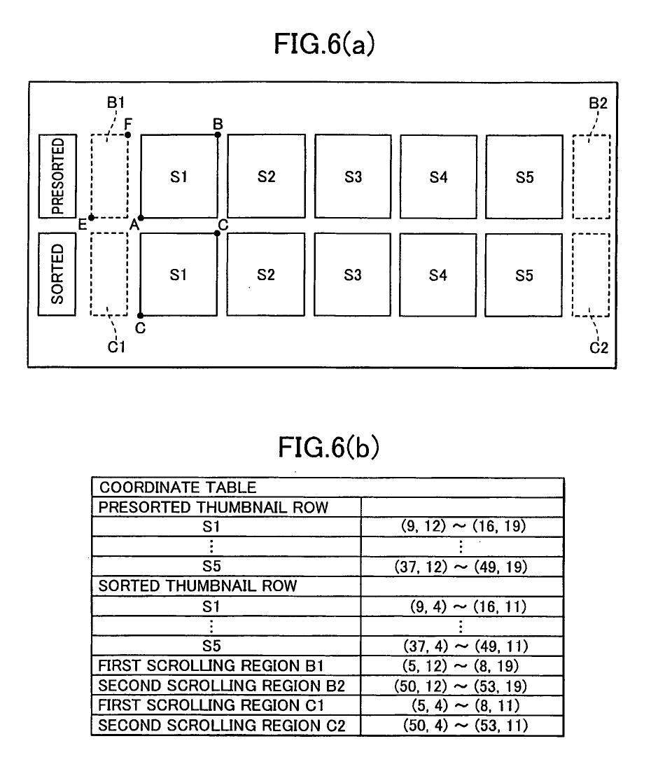

Next, a second embodiment of the present invention will be described with reference to FIGS. 6 through 8. In the second embodiment, first and second scrolling regions are provided for each of the presorted thumbnail row and sorted thumbnail row in place of the scroll bars 50 and 52 described in the first embodiment.

FIG. 6(a) is an explanatory diagram corresponding to FIG. 3(a) of the first embodiment and shows display positions of thumbnails and icons on the LCD 41 when the thumbnail image display of the second embodiment is displayed. FIG. 6(b) corresponds to FIG. 3(b) of the first embodiment and conceptually illustrates the coordinate table according to the second embodiment stored in the display region memory area 23a.

As described in the first embodiment, the thumbnail image display according to the second embodiment includes the presorted thumbnail row and the sorted thumbnail row, as shown in FIG. 6(a). In addition, a first scrolling region B1 indicated by a dotted line is provided adjacent to the left end of the presorted thumbnail row, and a second scrolling region B2 indicated by a dotted line is provided adjacent to the right end of the presorted thumbnail row. Similarly, a first scrolling region C1 indicated by a dotted line is provided adjacent to the left end of the sorted thumbnail row, and a second scrolling region C2 indicated by a dotted line is provided adjacent to the right end of the sorted thumbnail row. In FIG. 6(a), these display regions are left blank without any icons visible to the user.

The first scrolling region B1 is assigned as a region for accepting an instruction to scroll thumbnails in the presorted thumbnail row rightward in the drawing, while the second scrolling region B2 is assigned as a region for accepting an instruction to scroll thumbnails in the presorted thumbnail row leftward in the drawing. Similarly, the first scrolling region C1 is assigned as a region for accepting an instruction to scroll thumbnails in the sorted thumbnail row rightward in the drawing, while the second scrolling region C2 is assigned as a region for accepting an instruction to scroll thumbnails in the sorted thumbnail row leftward in the drawing.

The coordinate table shown in FIG. 6(b) stores the display regions S1-S5 for displaying thumbnails in each of the thumbnail rows in association with coordinates on the LCD 41, as described in the first embodiment. In addition, the coordinate table shown in FIG. 6(b) stores the first scrolling region B1, second scrolling region B2, first scrolling region C1, and second scrolling region C2 in association with their respective coordinates on the LCD 41.

More specifically, the first scrolling region B1 is stored in the coordinate table in association with two points E and F on the LCD 41 having coordinates (5, 12) and (8, 19), respectively, which coordinates define a rectangular region corresponding to the first scrolling region B1. Similarly, the second scrolling region B2, first scrolling region C1, and second scrolling region C2 are also stored in the coordinate table in association with coordinates for two points on the LCD 41.

In this way, a touch panel or the like configuring the LCD 41 can detect when one of the scrolling regions B1, B2, C1, and C2 has been touched.

Further, since the first scrolling region B1 is provided adjacent to the left end of the presorted thumbnail row and the second scrolling region B2 adjacent to the right end of the same row, the user can easily recognize that both scrolling regions B1 and B2 correspond to the presorted thumbnail row. Similarly, since the first scrolling region C1 is provided adjacent to the left end of the sorted thumbnail row and the second scrolling region C2 adjacent to the right end of the same row, the user can easily recognize that both scrolling regions C1 and C2 correspond to the sorted thumbnail row.

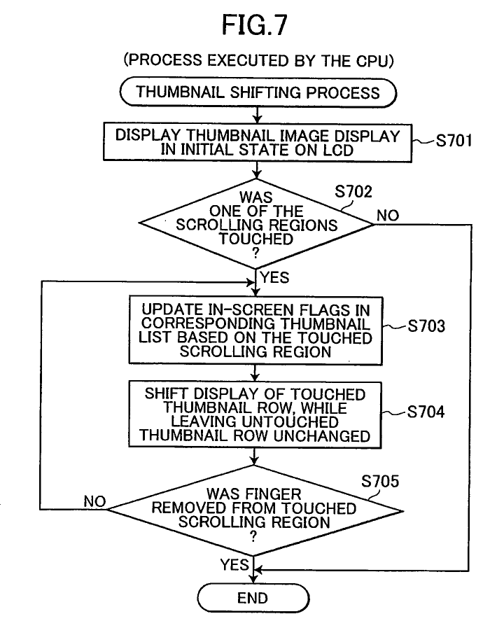

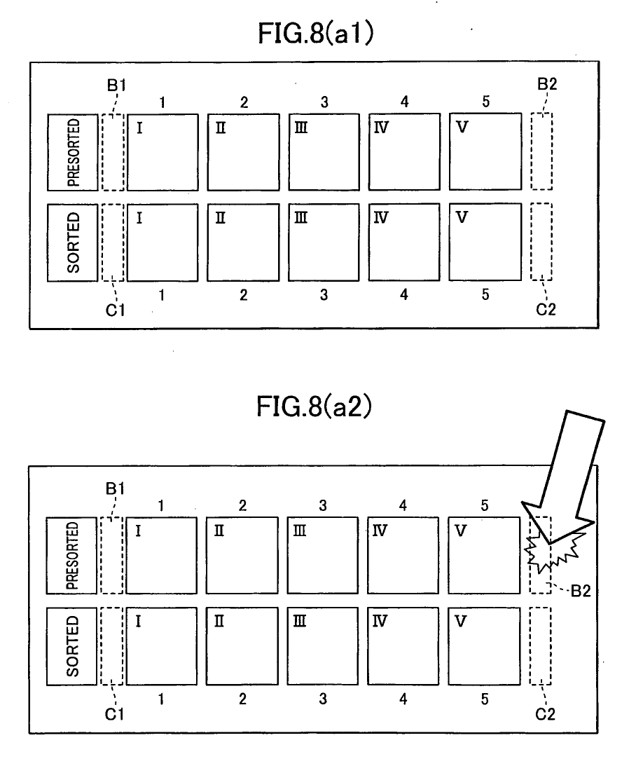

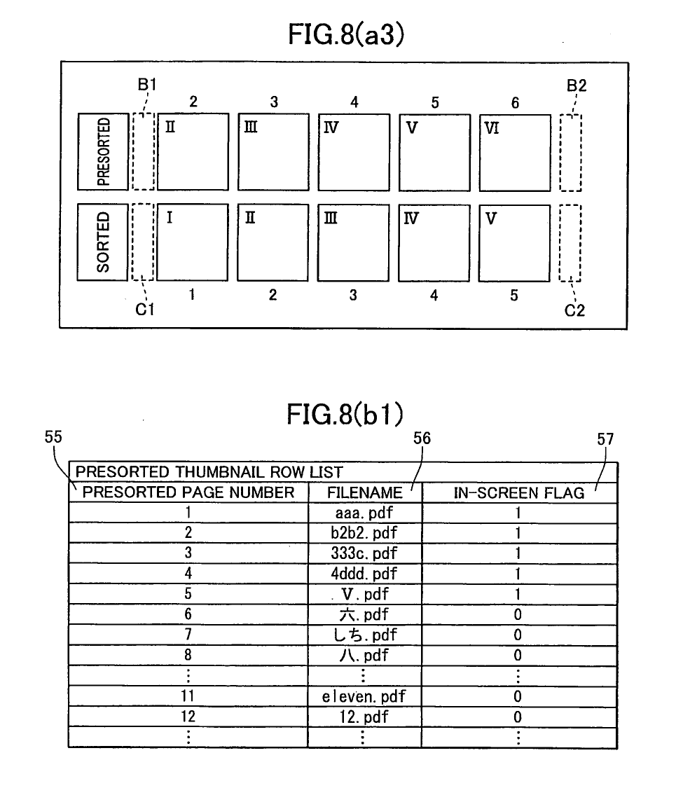

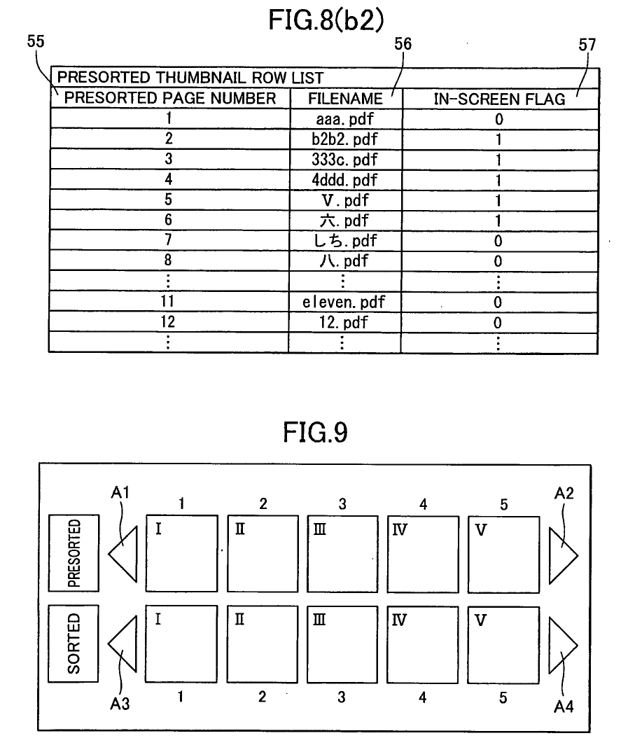

FIG. 7 is a flowchart illustrating steps in a thumbnail shifting process according to the second embodiment. In S701 of this process, the CPU 21 displays the thumbnail image display in its initial state on the LCD 41. For example, the thumbnail image display in the initial state shown in FIG. 8(a1) may be displayed in S701. Since the process in S701 is identical to that in S401 of FIG. 4, a detailed description of this process will not be repeated. However, CPU 21 displays no icons in the thumbnail image display for the scrolling regions B1, B2, C1, and C2, leaving these areas blank, as shown in FIG. 8(a1).

After displaying the initial state of the thumbnail image display in S701, in S702 the CPU 21 determines whether one of the scrolling regions B1, B2, C1, and C2 has been touched. If none of the scrolling regions have been touched (S702: NO), the CPU 21 ends the thumbnail shifting process. However, if one of the scrolling regions has been touched (S702: YES), in S703 the CPU 21 updates the in-screen flags 57 in the thumbnail list based on the touched scrolling region. More specifically, the CPU 21 shifts the five consecutive in-screen flags 57 set to “1” one page higher or lower. In S704 the CPU 21 changes the display of thumbnails in the thumbnail row corresponding to the touched region, while leaving the thumbnail row corresponding to the untouched region unchanged.

In S705 the CPU 21 detects whether the contact in the touched scrolling region has been released. If the CPU.21 does not detect that the touched scrolling region has been released (S705: NO), the CPU 21 repeats the process from S703. In this way, the thumbnail images displayed in one thumbnail row are continually shifted while the user continues to touch the scrolling region. However, when the CPU 21 detects that the scrolling region is no longer touched (S705: YES), the CPU 21 ends the thumbnail shifting process.

The process shown in the flowchart of FIG. 7 will be described in greater detail with reference to FIG. 8. FIG. 8(a2) shows the initial state of the thumbnail image display in FIG. 8(a1) when the user is touching the second scrolling region B2. FIG. 8(a3) shows the thumbnail image display after the presorted thumbnail row has been scrolled. FIG. 8(b2) is the list of presorted thumbnails after the in-screen flags 57 corresponding to the initial state shown in FIG. 8(b1) have been updated.

Hence, while the thumbnail image display is in its initial state shown in FIG. 8(a1), the user touches the second scrolling region B2 indicated by the point of the arrow in FIG. 8(a2).

At this time, the CPU 21 detects the coordinates of the LCD 41 touched by the user and determines which of the scrolling regions B1, B2, C1, and C2 was touched by referencing the coordinate table with the detected coordinates. In this example, the CPU 21 detects that the second scrolling region B2 was touched.

Next, the CPU 21 updates the list of presorted thumbnails shown in the initial state of FIG. 8(b1) to the state shown in FIG. 8(b2). Specifically, the CPU 21 changes the in-screen flag 57 corresponding to the page number 55 “1” from “1” to “0” and the in-screen flag 57 corresponding to the page number 55 “6” from “0” to “1”.

Next, the CPU 21 updates the thumbnail image display from the state shown in FIG. 8(a1) to the state shown in FIG. 8(a3) based on the updated list of presorted thumbnails shown in FIG. 8(b2). That is, the CPU 21 scrolls the thumbnails displayed in the presorted thumbnail row shown in FIG. 8(a1) one page to the left, displaying the five thumbnails corresponding to page numbers 55 “2-6” (roman numerals II-VI) from left to right in the presorted thumbnail row in increasing order of page numbers 55, as shown in FIG. 8(a3).

Through the thumbnail shifting process according to the second embodiment described above, as in the first embodiment described earlier, the multifunction device 1 can maintain the display of one of the presorted thumbnail row and sorted thumbnail row, while shifting the display of thumbnails in the other thumbnail row according to the user's instructions.

While the second embodiment describes the case of shifting the display in the presorted thumbnail row, the user may also touch the first scrolling region C1 or second scrolling region C2 to shift the display in the sorted thumbnail row while leaving the presorted thumbnail row unchanged.

Further, while the multifunction device 1 according to the second embodiment described above continually scrolls a row of thumbnails while the user continues to touch one of the scrolling regions, the multifunction device 1 may be configured to scroll one page worth each time a scrolling region is touched, whether or not the user continues to touch the scrolling region.

Next, a variation of the second embodiment will be described with reference to FIG. 9. FIG. 9 is an explanatory diagram corresponding to FIG. 8(a1) and shows the thumbnail image display in its initial state. In the second embodiment described above, no icons are displayed in the scrolling regions B1, B2, C1, and C2 of the thumbnail image display, as shown in FIG. 8(a1).

However, in this variation of the second embodiment, icons A1-A4 may be displayed at positions corresponding to the scrolling regions B1, B2, C1, and C2, as illustrated in FIG. 9. Displaying icons in this way enables the user to easily recognize positions corresponding to the scrolling regions.

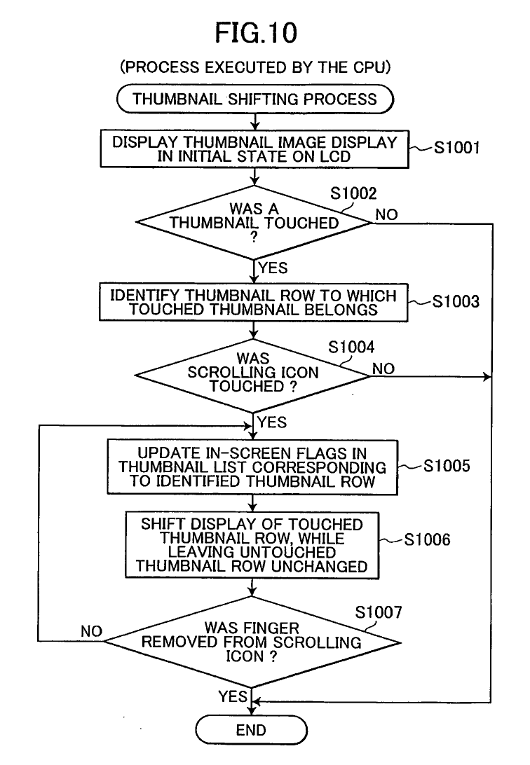

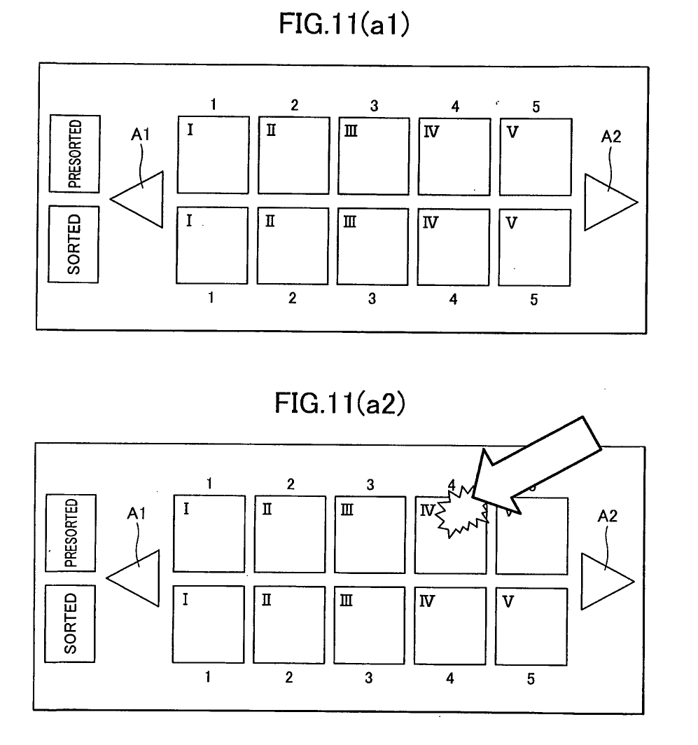

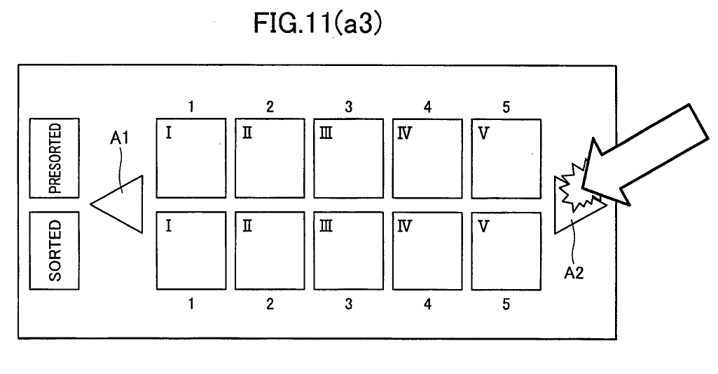

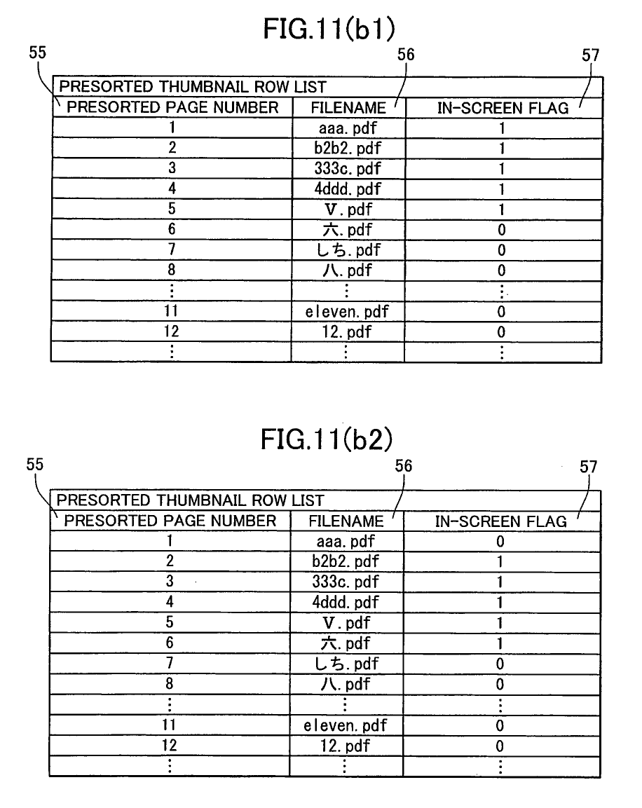

Next, a third embodiment of the present invention will be described with reference to FIGS. 10 and 11. In the third embodiment, common scrolling regions are set for and shared by the presorted thumbnail row and the sorted thumbnail row. The user designates a thumbnail row by touching one of the thumbnails therein, and subsequently touches the common scrolling regions to scroll the designated row. The multifunction device 1 shifts the thumbnail row in which the thumbnail was touched based on the instructions received by the scrolling regions.

FIG. 10 is a flowchart illustrating steps in the thumbnail shifting process according to the third embodiment. In S1001 of this process, the CPU 21 displays the thumbnail image display in its initial state on the LCD 41. For example, the thumbnail image display in the initial state shown in FIG. 11(a1) may be displayed in S1001. In the initial state of the thumbnail image display according to the third embodiment shown in FIG. 11(a1), the CPU 21 displays a first scrolling icon A1 adjacent to one longitudinal end of the presorted and sorted thumbnail rows and displays a second scrolling icon A2 adjacent to the other longitudinal end. As described earlier, coordinates indicating where the scrolling icons A1 and A2 are displayed on the LCD 41 are stored in the coordinate table.

The display region in which the first scrolling icon A1 is displayed is assigned as a region for accepting an instruction to scroll thumbnails in either the presorted thumbnail row or the sorted thumbnail row rightward in the drawing, while the display region in which the second scrolling icon A2 is displayed is assigned as a region for accepting an instruction to scroll thumbnails in either the presorted thumbnail row or the sorted thumbnail row leftward in the drawing.

After displaying the initial state of the thumbnail image display in S1001, in S1002 the CPU 21 determines whether one of the thumbnails has been touched. If a thumbnail has not been touched (S1002: NO), the CPU 21 ends the thumbnail shifting process. However, if one of the thumbnails was touched (S1002: YES), in S1003 the CPU 21 identifies the thumbnail row containing the touched thumbnail. In other words, determines whether the user touched a thumbnail belonging to the presorted thumbnail row or the sorted thumbnail row.

In S1004 the CPU 21 determines whether one of the scrolling icons A1 and A2 was touched. If neither of the scrolling icons was touched (S1004: NO), the CPU 21 ends the thumbnail shifting process. However, if one of the scrolling icons A1 and A2 was touched (S1004: YES), in S1005 the CPU 21 updates the in-screen flags 57 in the thumbnail list corresponding to the thumbnail row identified in S1003 based on the instruction indicated by the scrolling icon touched in S1004. More specifically, the CPU 21 shifts the five consecutive in-screen flags 57 set to “1” one page higher or lower.

In S1006 the CPU 21 scrolls the thumbnails in the relevant thumbnail row one page based on the updated in-screen flags 57, while leaving the untouched thumbnail row unchanged. In S1007 the CPU 21 detects whether the contact in the touched scrolling icon has been released. If the CPU 21 does not detect that the touched scrolling icon has been released (S1007: NO), the CPU 21 repeats the process from S1005. In this way, the thumbnail images displayed in one thumbnail row are continually shifted while the user continues to touch the scrolling icon. However, when the CPU 21 detects that the user is no longer touching the scrolling icon (S1007: YES), the CPU 21 ends the thumbnail shifting process.

The process shown in the flowchart of FIG. 10 will be described in greater detail with reference to FIG. 11. FIG. 11(a2) shows the initial state of the thumbnail image display in FIG. 11(a1) when the user is touching the fourth thumbnail from the left in the presorted thumbnail row. FIG. 11(a3) shows the thumbnail image display when the user has touched the second scrolling icon A2 after touching the thumbnail in the presorted thumbnail row. FIG. 11(b2) is the list of presorted thumbnails after the relevant in-screen flags 57 have been updated from the initial state shown in FIG. 11(b1).

Hence, while the thumbnail image display is in its initial state shown in FIG. 11(a1), the user touches the fourth thumbnail from-the left in the presorted thumbnail row, as indicated by the arrow point shown in FIG. 11(a2). At this time, the CPU 21 detects the coordinates of the LCD 41 touched by the user and identifies the thumbnail row containing the touched thumbnail by referencing the coordinate table with the detected coordinates. In this example, the CPU 21 identifies the touched thumbnail to belong to the presorted thumbnail row.

Subsequently, the user touches the second scrolling icon A2 as indicated by the arrow in FIG. 11(a3). At this time, the CPU 21 detects the coordinates of the LCD 41 touched by the user and determines which of the scrolling icons A1 or A2 was touched by referencing the coordinate table using the detected coordinates. In this example, the CPU 21 detects that the second scrolling icon A2 was touched.

Next, the CPU 21 updates the list of presorted thumbnails shown in FIG. 11(b1) to the state shown in FIG. 11(b2). Specifically, the CPU 21 changes the in-screen flag 57 corresponding to the page number 55 “1” from “1” to “0” and the in-screen flag 57 corresponding to the page number 55 “6” from “0” to “1”.

Next, the CPU 21 updates the thumbnail image display from the state shown in FIG. 11(a1) to the state shown in FIG. 11(a3) based on the updated list of presorted thumbnails shown in FIG. 11(b2). That is, the CPU 21 scrolls the thumbnails displayed in the presorted thumbnail row shown in FIG. 11(a1) one page to the left, displaying the five thumbnails corresponding to page numbers 55 “2-6” (roman numerals II-VI) from left to right in the presorted thumbnail row in increasing order of page numbers 55, as shown in FIG. 11(a3).

With the third embodiment described above, the thumbnail row including the initially touched thumbnail is identified as the thumbnail row to be scrolled, enabling the user to easily specify the thumbnail row to be scrolled. Further, since regions indicating scrolling instructions need not be provided for each thumbnail row, the display area of the LCD 41 can be used more efficiently.

While the third embodiment describes the case of shifting the display in the presorted thumbnail row, the user may also shift the display in the sorted thumbnail row in the same manner described above, while maintaining the display in the presorted thumbnail row unchanged, by first touching one of the thumbnails in the sorted thumbnail row and subsequently touching one of the scrolling icons A1 and A2.

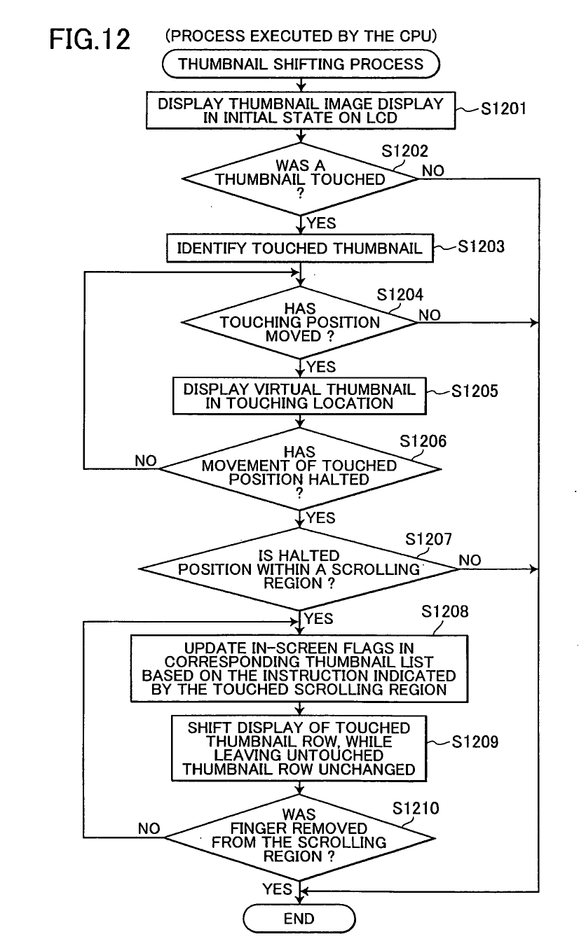

Next, a fourth embodiment of the present invention will be described with reference to FIGS. 12 and 14. As in the second embodiment described above, the multifunction device 1 according to the fourth embodiment provides the scrolling regions B1, B2, C1, and C2 in the thumbnail image display. When the user touches a thumbnail in one of the thumbnail rows and subsequently traces a prescribed path to one of the scrolling regions, the multifunction device 1 scrolls the corresponding thumbnail row according to the instruction given by the touched scrolling region.

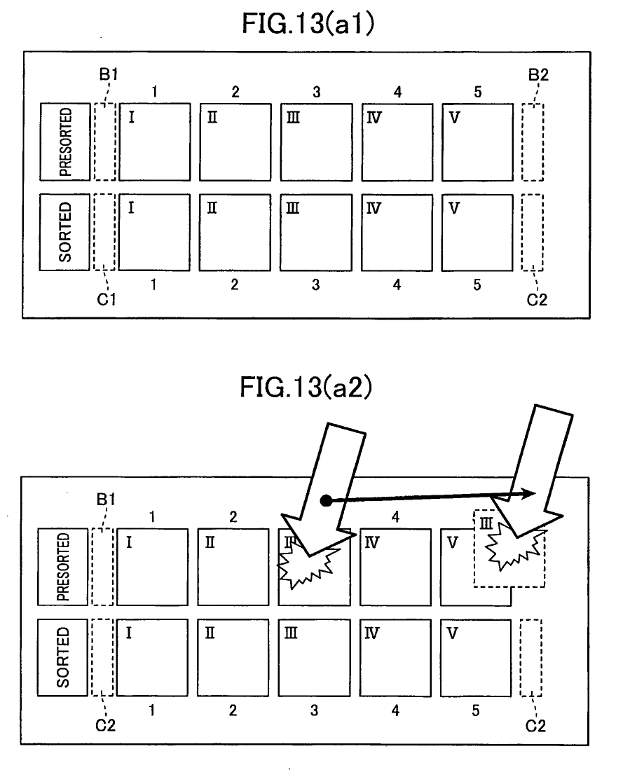

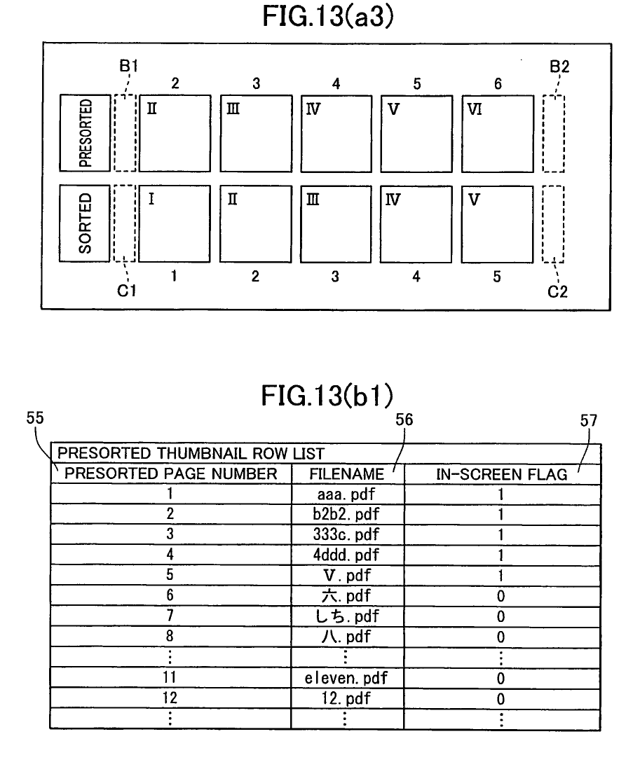

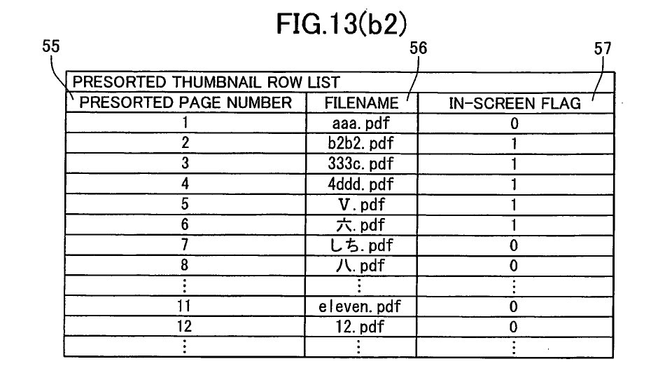

FIG. 12 is a flowchart illustrating steps in the thumbnail shifting process according to the fourth embodiment. In S1201 of this process the CPU 21 displays the thumbnail image display in its initial state on the LCD 41. For example, the thumbnail image display in the initial state shown in FIG. 13(a1) may be displayed in S1201. As described in the second embodiment, coordinates indicating where the scrolling regions B1, B2, C1, and C2 are displayed on the LCD 41 are stored in the coordinate table.

After displaying the initial state of the thumbnail image display in S1201, in S1202 the CPU 21 determines whether one of the thumbnails has been touched. If a thumbnail has been touched (S1202: YES), in S1203 the CPU 21 identifies the touched thumbnail.

In S1204 the CPU 21 determines whether the touched position has moved. If the touched position has not moved (S1204: NO), the CPU 21 ends the thumbnail shifting process. However, if the touched position has moved (S1204: YES), in S1205 the CPU 21 displays a virtual thumbnail identical to the thumbnail selected prior to movement. In S1206 the CPU 21 determines whether the touched position has halted. If the touched position has not halted (S1206: NO), the CPU 21 repeats the process from S1204. When the touched position has halted (S1206: YES), in S1207 the CPU 21 detects the coordinates at the halted position and determines whether the detected coordinates correspond to one of the scrolling regions B1, B2, C1, and C2.

If the halted position does not correspond to a scrolling region (S1207: NO), the CPU 21 ends the thumbnail shifting process. However, if the halted position corresponds to one of these scrolling regions (S1207: YES), in S1208 the CPU 21 updates the in-screen flags 57 in the thumbnail list based on the touched scrolling region. More specifically, the CPU 21 shifts the five consecutive in-screen flags 57 set to “1” one page higher or lower based on the touched scrolling region.

In S1209 the CPU 21 scrolls the thumbnails in the relevant thumbnail row one page based on the updated in-screen flags 57, while leaving the untouched thumbnail row unchanged. In S1210 the CPU 21 detects whether the contact in the touched scrolling region has been released. If the CPU 21 does not detect that the touched scrolling region has been released (S1210: NO), the CPU 21 repeats the process from S1208. In this way, the thumbnails displayed in one thumbnail row are continually shifted while the user continues to touch the scrolling region. However, when the CPU 21 detects that the user is no longer touching the scrolling region (S1210: YES), the CPU 21 ends the thumbnail shifting process.

The process shown in the flowchart of FIG. 12 will be described in greater detail with reference to FIG. 13. FIG. 13(a2) shows the initial state of the thumbnail image display in FIG. 13(a1) when the user touches the third thumbnail from the left in the presorted thumbnail row and subsequently moves the touching position, as indicated by the arrows. FIG. 13(a3) shows the thumbnail image display after scrolling the presorted thumbnail row. FIG. 13(b2) is the list of presorted thumbnails updated from the initial state shown in FIG. 13(b1).

Hence, while the thumbnail image display is in its initial state shown in FIG. 13(a1), the user touches the third thumbnail from the left in the presorted thumbnail row, as indicated by the arrow shown in FIG. 13(a2), subsequently moves the touching position, and halts the touching position at a position in the second scrolling region B2.

At this time, the CPU 21 detects the coordinates of the LCD 41 touched by the user and identifies the touched thumbnail by referencing the coordinate table with the detected coordinates. In this example, the CPU 21 identifies the thumbnail having the page number 55 “3” as the touched thumbnail.

If the touched position of the user's finger moves subsequently, the CPU 21 detects the coordinates of the new position and displays a thumbnail similar to the initially touched thumbnail at the detected coordinates, as shown in FIG. 13(a2).

If the position touched by the user stops moving, the CPU 21 detects the coordinates at the halted position and determines whether the user's finger halted at a position within one of the scrolling regions B1, B2, C1, and C2 by referencing the coordinate table with the detected coordinates. In this example, the CPU 21 detects that the user's finger halted at a position within the second scrolling region B2.

Next, the CPU 21 updates the list of presorted thumbnails shown in FIG. 13(b1) to the state shown in FIG. 13(b2). Specifically, the CPU 21 changes the in-screen flag 57 corresponding to the page number 55 “1” from “1” to “0” and the in-screen flag 57 corresponding to the page number 55 “6” from “0” to “1”.

Next, the CPU 21 updates the thumbnail image display from the state shown in FIG. 13(a1) to the state shown in FIG. 13(a3) based on the updated list of presorted thumbnails shown in FIG. 13(b2). That is, the CPU 21 scrolls the thumbnails displayed in the presorted thumbnail row shown in FIG. 13(a1) one page to the left, displaying the five thumbnails corresponding to page numbers 55 “2-6” (roman numerals II-VI) from left to right in the presorted thumbnail row in increasing order of page numbers 55, as shown in FIG. 13(a3).

Through the thumbnail shifting process according to the fourth embodiment described above, when the user touches a thumbnail, the CPU 21 displays a thumbnail image identical to the initially touched thumbnail at the touching position so as to move along with the touching position until the user's finger separates from the LCD 41. Accordingly, the user can visually follow the movement of the initially touched thumbnail at all times.

While the fourth embodiment describes the case of shifting the display in the presorted thumbnail row, the user may also shift the display in the sorted thumbnail row, while maintaining the display in the presorted thumbnail row unchanged, by touching one of the scrolling regions C1 and C2.

Although the present invention has been described with respect to specific embodiments, it will be appreciated by one skilled in the art that a variety of changes may be made without departing from the scope of the invention.

For example, when the scroll bars 50 and 52 are displayed in the first embodiment described above, numbers indicating the display order may be displayed in the divided sections of the scroll bars, providing the user with a guideline to determine which divided section of the first scroll bar 50 or second scroll bar 52 to touch.

Further, while a touch panel is used in the preferred embodiments to identify a display region on the LCD 41 touched by the user, the present invention is not limited to a touch panel method in which the user directly touches the LCD 41, but may employ a touch panel capable of detecting coordinates on the LCD 41 based on physical proximity to the LCD 41 or the like.

Further, the thumbnails may be scrolled by only touching the thumbnail row.

What is claimed is:

1. An image-displaying device comprising:
a storing unit configured to store a first correlation data and a second correlation data, the first correlation data indicating a plurality of first thumbnails including a plurality of first display thumbnails and also indicating a sequence of the plurality of first thumbnails, the second correlation data indicating a plurality of second thumbnails including a plurality of second display thumbnails and also indicating a sequence of the plurality of second thumbnails;
a displaying unit including a first display configured to display a plurality of first display thumbnails as a first thumbnail row extending in a predetermined direction based on the first correlation data, and a second display configured to display a plurality of second display thumbnails as a second thumbnail row extending in the predetermined direction based on the second correlation data;
a receiving unit including a first receiving unit configured to receive a first changing instruction, and a second receiving unit configured to receive a second changing instruction;
a detecting unit configured to detect that the first receiving unit has received the first changing instruction and the second receiving unit has received the second changing instruction; and
a controller configured to control the first display to change a first display thumbnail in the first thumbnail row and to control the second display to maintain displaying the plurality of second display thumbnails if the detecting unit detects that the first receiving unit has received the first changing instruction, and the controller configured to control the second display to change a second display thumbnail in the second thumbnail row and to control the first display to maintain displaying the plurality of first display thumbnails if the detecting unit detects that the second receiving unit has received the second changing instruction.

2. The image-displaying device according to claim 1, wherein the displaying unit further includes a first instruction region and a second instruction region, the first receiving unit receiving the first changing instruction when the first instruction region is touched, the second receiving unit receiving the second changing instruction when the second instruction region is touched.

3. The image-displaying device according to claim 2, wherein the first thumbnail row is positioned between the first instruction region and the second thumbnail row, and the second thumbnail row is positioned between the second instruction region and the first thumbnail row.

4. The image-displaying device according to claim 2, wherein the controller controls the first instruction region to display a first icon and controls the second instruction region to display a second icon.

5. The image-displaying device according to claim 2, wherein the controller controls the first instruction region to display a blank and controls the second instruction region to display a blank.

6. The image-displaying device according to claim 3, wherein the first instruction region includes a plurality of first divisions arrayed in the predetermined direction, and the second instruction region includes a plurality of second divisions arrayed in the predetermined direction, the first receiving unit receiving the first changing instruction when one of the plurality of first divisions is touched, the second receiving unit receiving the second changing instruction when one of the plurality of second divisions is touched,
wherein the storing unit stores each of the plurality of first divisions in association with the sequence of the plurality of first thumbnails, and each of the plurality of second divisions in association with the sequence of the plurality of first thumbnails,
wherein the detecting unit detects the touched first division and the touched second division,
wherein the controller controls the first display to scroll the first thumbnail row in the predetermined direction a prescribed amount corresponding to the touched first division if the detecting unit detects that one of the plurality of first divisions has been touched, and the controller controls the second display to scroll the second thumbnail row in the predetermined direction a prescribed amount corresponding to the touched second division if the detecting unit detects that one of the plurality of second divisions has been touched.

7. The image-displaying device according to claim 2, wherein the first instruction region is positioned adjacent to the first thumbnail row in the predetermined direction, and the second instruction region is positioned adjacent to the second thumbnail row in the predetermined direction.

8. The image-displaying device according to claim 7, wherein the controller controls the first instruction region to display a first icon and controls the second instruction region to display a second icon.

9. The image-displaying device according to claim 7, wherein the controller controls the first instruction region to display a blank and controls the second instruction region to display a blank.

10. The image-displaying device according to claim 7, wherein the first receiving unit receives the first changing instruction when the first instruction region has been touched continuously for a prescribed time, and the second receiving unit receives the second changing instruction when the second instruction has been touched continuously for the prescribed time,
wherein the detecting unit detects that the first instruction region has been touched continuously for the prescribed time and the second instruction region has been touched continuously for the prescribed time,
wherein the controller controls the first display to scroll the first thumbnail row in the predetermined direction a prescribed amount if the detecting unit detects that the first instruction region has been touched continuously for the prescribed time, and controls the second display to scroll the second thumbnail row in the predetermined direction a prescribed amount if the detecting unit detects that the second instruction region has been touched continuously for the prescribed time.

11. The image-displaying device according to claim 7, wherein the first receiving unit receives the first changing instruction when the first instruction region has been touched a plurality of times consecutively, and the second receiving unit receives the second changing instruction when the second instruction has been touched the plurality of times consecutively,
wherein the detecting unit detects that the first instruction region has been touched a plurality of times consecutively and the second instruction region has been touched a plurality of times consecutively,
wherein the controller controls the first display to scroll the first thumbnail row in the predetermined direction a prescribed amount if the detecting unit detects that the first instruction region has been touched a plurality of times consecutively, and controls the second display to scroll the second thumbnail row in the predetermined direction a prescribed amount if the detecting unit detects that the second instruction region has been touched a plurality of times consecutively.

12. The image-displaying device according to claim 2, wherein the first instruction region is positioned in a region of the first display on which the first thumbnail row is displayed, and the second instruction region is positioned in a region of the second display on which the second thumbnail row is displayed.

13. The image-displaying device according to claim 12, wherein the displaying unit further includes a scroll region, and the detecting unit detects that the scroll region has been touched after either the first instruction region or the second instruction region had been touched,
wherein the controller controls the first display to scroll the first thumbnail row in the predetermined direction a prescribed amount if the detecting unit detects that the scroll region has been touched after the first instruction region had been touched, and the controller controls the second display to scroll the second thumbnail row in the predetermined direction the prescribed amount if the detecting unit detects that the scroll region has been touched after the second instruction region had been touched.

14. The image-displaying device according to claim 12, wherein the controller controls the scroll region to display an icon.

15. The image-displaying device according to claim 12, wherein the controller controls the scroll region to display a blank.

16. The image-displaying device according to claim 12, wherein the touched thumbnail is draggable, and is displayed until the thumbnail is stopped to be dragged.
